(19) United States
(12) Patent Application Publication
(10) Pub. No.: US 2005/0140103 A1
(43) Pub. Date: Jun. 30, 2005

(54) Carrying bag for folding chair

(76) Inventors: Michael D. Marchant, Wichita, KS (US); Katie E. Lewis, Wichita, KS (US)

Correspondence Address: Richard C. Litman;LITMAN LAW OFFICES, LTD., P.O. Box 15035, Arlington, VA, 22215, US

(21) Appl. No.: 10/747,168

(22) Filed: Dec. 30, 2003

(51) Int. Cl. B62B 1/00

(52) U.S. Cl. 280/47.26

(57) ABSTRACT

A carrying bag for a folding chair, which bag includes a retractable handle and is mounted on wheels whereby the bag can be pulled or pushed along a surface. Legs are mounted to the base of the bag, opposite the wheels, to provide support when the bag is resting in an upright position. Plural pockets are disposed on the outer surface of the bag for carrying items of various sizes therein. The open top of the bag is provided with a drawstring whereby the top may be closed to secure the chair therein.

### BACKGROUND OF THE INVENTION

1. Field of the Invention

The present invention generally relates to backpacks. More specifically, the present invention is drawn to a backpack for transporting a collapsible or folding chair therein.

2. Description of the Related Art

Personal collapsible chairs have become the rage at recreational venues. At beaches, ballparks, picnics, etc., the collapsible chair has become a desired staple. A vexing problem, however, is how does one efficiently transport the cumbersome chair to the chosen venue along with other items needed for an enjoyable recreational outing. There have been many attempts, as shown in the related art, to solve this problem. For example, U.S. Pat. No. 5,570,829 (Harrison), U.S. Pat. No. 5,893,504 (Baronian et al. and U.S. Pat. No. 5,927,798 (Ahn) disclose backpacks for folding chairs. All of the instant backpacks lack the versatility of the backpack of Applicant's invention.

U.S. Pat. No. 5,515,954 (Nordstrom) and U.S. Pat. No. 5,927,450 (Sadow) show wheeled luggage structures. These structures cannot function as backpacks.

U.S. Pat. No. 6,056,301 (Berliner et al.) and U.S. Pat. No. 6,634,496 B2 (Scoglio) are drawn to wheeled golf bags. The wheeled bags could not contain a collapsible chair.

U.S. Patent Publication 2002/0145018 A1 (Godshaw et al.) relates to a backpack that is convertible from wheeled luggage. No provision is made to transport a collapsible chair.

U.S. Pat. No. 5,620,229 (Ledford) discloses an article of manufacture useful to cover and bag a folding lounge chair. The patentee does not contemplate providing alternative structure for transporting the chair.

None of the above inventions and patents, taken either singly or in combination, is seen to disclose a collapsible chair container having alternative transporting structure as will be subsequently described and claimed in the instant invention.

### SUMMARY OF THE INVENTION

The instant invention is a carrying bag for a folding chair. The bag includes a retractable handle and is mounted on wheels whereby the bag can be pulled or pushed along a surface. Legs are mounted to the base of the bag, opposite the wheels, to provide support when the bag is resting in an upright position. Plural pockets are disposed on the outer surface of the bag for carrying items of various sizes therein. The open top of the bag is provided with a drawstring whereby the top may be closed to secure the chair therein.

A clear understanding of the invention will become readily apparent upon further review of the following specification and drawings.

### BRIEF DESCRIPTION OF THE DRAWINGS

FIG. 1 is an environmental, perspective view of a carrying bag for folding chair according to the present invention.

FIG. 2 is a front view of a carrying bag for a folding chair according to the present invention.

FIG. 3 is a rear view of a carrying bag for a folding chair according to the present invention.

Similar reference characters denote corresponding features consistently throughout the attached drawings.

### DETAILED DESCRIPTION OF THE PREFERRED EMBODIMENT

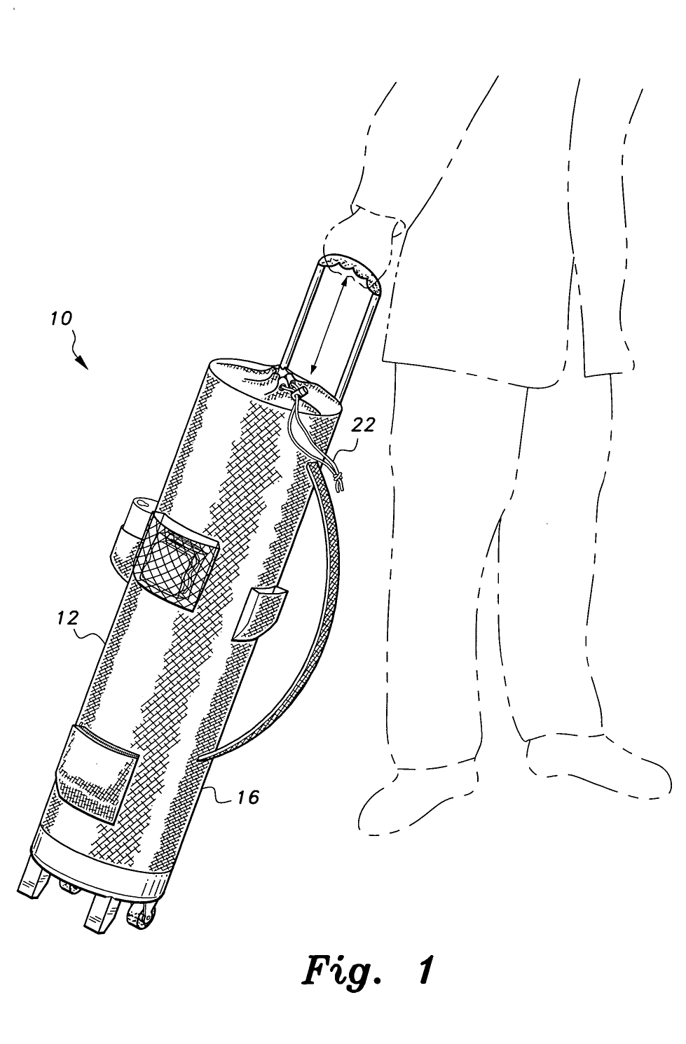

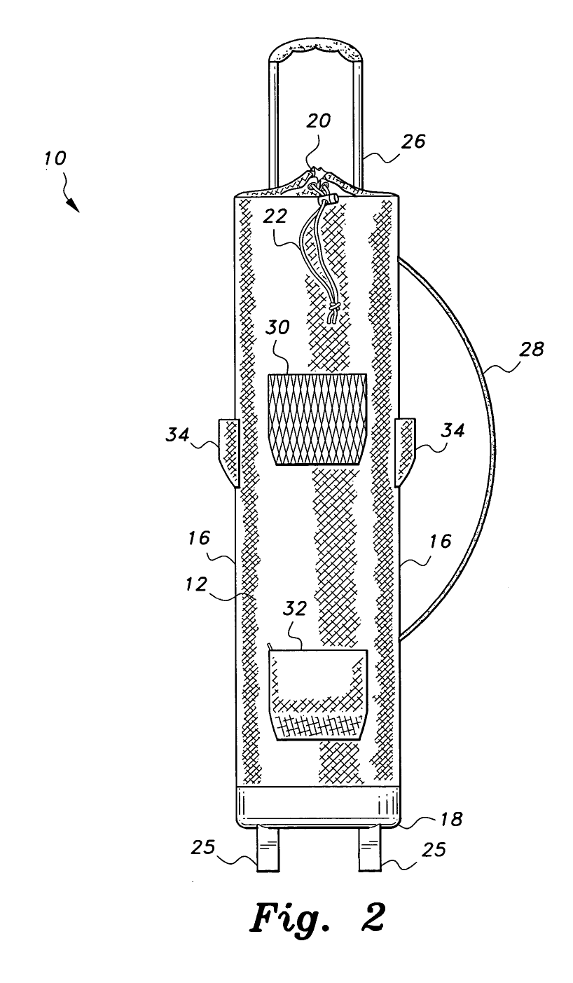

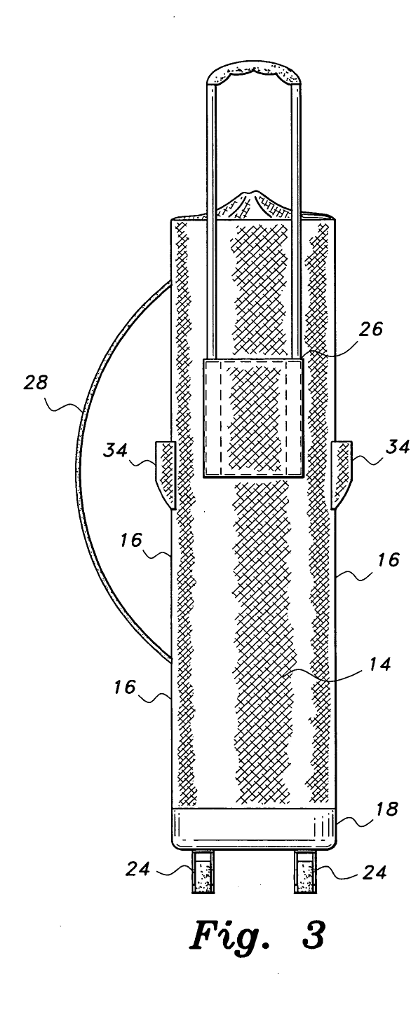

Attention is directed to FIG. 1-3, wherein the carrying bag of the present invention is generally designated at 10. Bag 10 is fabricated from a flexible, durable material having front 12, rear 14 and side 16 surfaces. The bottom of the bag is closed with a plastic base 18. The front, rear, sides and bottom enclose a volume having an open top. A peripheral edge 20 defines the upper extremity of the open top. A conventional drawstring 22 is disposed in the edge for closing the open top when a chair is disposed in the bag.

A pair of casters 24 is mounted to the plastic base 18 adjacent to rear surface 14. A pair of support legs 25 is mounted to the bottom plastic base adjacent to the front surface 12. Retractable handle structure 26 is disposed on the rear surface such that the gripping portion of the handle extends above the open top. A shoulder strap 28 is mounted on one side 16 of the bag. This structural arrangement allows a user to either roll or carry the bag.

Mesh pocket 30 and closed pocket 32 are mounted on the front surface 12. Both pockets may be provided with zippered closures. Open pockets 34 are mounted on side surfaces 16. The pockets are made in various sizes for carrying items (bottles, toiletries, etc.) therein.

It is to be understood that the present invention is not limited to the embodiment described above, but encompasses any and all embodiments within the scope of the following claims.

1. A carrying bag for a folding chair, comprising:
a receptacle, said receptacle having a front surface, a rear surface, two side surfaces, a bottom surface and an open top;
a pair of casters, said pair of casters disposed on said bottom surface adjacent to said rear surface;
a pair of support legs, said pair of support legs disposed on said bottom surface adjacent to said front surface; and
a shoulder strap disposed on one of said two side surfaces.

2. The carrying bag for a folding chair as recited in claim 1, wherein said bottom surface is fabricated from a plastic material.

3. The carrying bag for a folding chair as recited in claim 1, including a retractable handle disposed on said rear surface.

4. The carrying bag for a folding chair as recited in claim 1, including pockets disposed on said front surface and said two side surfaces.

5. The carrying bag for a folding chair as recited in claim 4, wherein one of said pockets is fabricated from mesh material.

6. The carrying bag for a folding chair as recited in claim 1, wherein said open top is defined by a peripheral edge and including a drawstring disposed in said peripheral edge.

7. A carrying bag for a folding chair, comprising:
a receptacle fabricated from a flexible, durable material, said receptacle having a front surface, a rear surface, two side surfaces, a bottom surface fabricated from a plastic material and an open top;
a pair of casters, said pair of casters disposed on said bottom surface adjacent to said rear surface;
a pair of support legs, said pair of support legs disposed on said bottom surface adjacent to said front surface; and
a shoulder strap disposed on one of said two side surfaces.

8. The carrying bag for a folding chair as recited in claim 7, including a retractable handle disposed on said rear surface.

9. The carrying bag for a folding chair as recited in claim 8, including pockets disposed on said front surface and said two side surfaces.

10. The carrying bag for a folding chair as recited in claim 9, wherein one of said pockets is fabricated from mesh material.

11. The carrying bag for a folding chair as recited in claim 8, wherein said open top is defined by a peripheral edge and including a drawstring disposed in said peripheral edge.
